(19) United States
(12) Patent Application Publication
(10) Pub. No.: US 2026/0340590 A1
(43) Pub. Date: Oct. 29, 2026

(54) Real-time work and performance visibility, tracking, and analysis for transparent lump sum contracting

(71) Applicant: Management Controls, Inc., Houston, TX (US)

(72) Inventors: Jason DUANE, Kingwood, TX (US); Michael MANTOOTH, Wilsonville, AL (US); Francisco TREVINO, Jersey Village, TX (US); Cody WERBELOW, Sand Springs, OK (US); Ali AGAH, Houston, TX (US)

(73) Assignee: Management Controls, Inc., Houston, TX (US)

(21) Appl. No.: 19/662,625

(22) Filed: Apr. 29, 2026

Related U.S. Application Data
(60) Provisional application No. 63/796,558, filed on Apr. 29, 2025.

(51) Int. Cl. G06Q 10/1091; G06Q 10/0631

(52) U.S. Cl. CPC G06Q 10/1091; G06Q 10/06316

(57) ABSTRACT

Techniques relating to real-time work and performance visibility, tracking, and analysis for transparent lump sum contracting are disclosed. A transparent lump sum (TLS) system may include a processor, a database configured to store database tables containing project and change order information, along with other project-related information, and a memory comprising program instructions executable by the processor to cause the processor to implement a set of applications configured to track actual time and materials spent, and execute payments, for a project associated with a lump sum contract, an AI model configured to generate a post-project analysis relating to the lump sum contract project, the AI model trained using actuals data for previously completed projects and milestone payment definitions, and a user interface configured to enable project creation and to generate a visualization associated with the post-project analysis.

### CROSS-REFERENCE TO RELATED APPLICATIONS

This application claims the benefit of U.S. Provisional Patent Application No. 63/796,558 entitled “Methods and systems for providing real-time work and performance visibility, tracking, and analysis for transparent lump sum contracting,” filed Apr. 29, 2025, all of which is hereby incorporated by reference in their entirety.

### BACKGROUND OF INVENTION

Traditional lump sum contracts are widely used for maintenance, turnaround, and project work due to their simplicity in billing and reduced administrative overhead. As such, lump sum contracting is a widely used strategy across various types of work, including major capital builds, routine maintenance, and small project execution. The primary intention behind lump sum contracts is to simplify payment processes and reduce administrative burdens. However, traditional lump sum models often introduce several challenges:
Limited Visibility: There is often a lack of transparency regarding the actual work performed, making it difficult to validate milestone-based payments.
Billing Risks: Overbilling or duplicated charges can occur when the same labor is allocated across multiple jobs, in addition to equipment usage costs and material expense costs.
Performance Tracking: Poor tracking of subcontractors and the percentage of work completed can lead to inefficiencies.
Comparison Challenges: It is challenging to compare performance with Time & Materials (T&M) contracts in real-time.
Vendor Accountability: Ensuring vendors deliver on expectations is difficult without clear visibility into their performance.

These contracts often introduce blind spots, billing risks, and limited performance visibility. These gaps make it hard to ensure that vendors are meeting expectations and to determine if lump sum is the right strategy for a given job or vendor.

Therefore, improved methods and systems for providing real-time work and performance visibility, tracking, and analysis for transparent lump sum contracting are desirable.

### BRIEF SUMMARY

A system and method are disclosed for real-time work and performance visibility, tracking, and analysis for transparent lump sum contracting. A system for real-time work and performance visibility, tracking, and analysis for transparent lump sum contracting, the system may include: a processor; a database configured to store a plurality of database tables, including one, or a combination, of a project master table, a lump sum cost object assignments table, a project milestone assignments table, a lump sum activities table, a lump sum line item assignments table, a change orders table, and a lump sum resource type assignments table; and a memory comprising program instructions executable by the processor to cause the processor to implement: a set of applications configured to track actual time and materials spent, and execute payments, for a project associated with a lump sum contract; an AI model configured to generate a post-project analysis relating to the lump sum contract project, the AI model trained using actuals data for previously completed projects and milestone payment definitions; and a user interface configured to enable project creation and to generate a visualization associated with the post-project analysis.

In some examples, the processor further implements a Kubernetes service configured to deploy and manage the set of applications. In some examples, the Kubernetes service is configured to receive data from a web browser implementing a user interface component. In some examples, the Kubernetes service is configured to receive data from an enterprise resource planning client. In some examples, the actuals data comprises one, or a combination, of labor actuals, equipment actuals, and materials actuals. In some examples, the processor further implements an API management layer.

In some examples, the project master table comprises a central table containing core project information. In some examples, the lump sum cost object assignments table links a project and/or a change order to a cost object. In some examples, the project milestone assignments table links to the project master table and tracks milestone assignments within the project. In some examples, the lump sum activities table links to one or both of project master table and project milestone assignments table, the lump sum activities table being configured to track an activity with its cost and work date(s). In some examples, the lump sum line item assignments table contains line items associated with the project and/or a change order. In some examples, the change orders table is configured to capture a modification to a project scope, the change orders table further including a cost estimate for the modification. In some examples, the lump sum resource type assignments table is configured to track resource allocation for the project or a change order.

### BRIEF DESCRIPTION OF THE DRAWINGS

FIG. 1 is a simplified block diagram illustrating an exemplary method for providing real-time work and performance visibility, tracking, and analysis for transparent lump sum contracting, in accordance with one or more embodiments.

FIG. 2 is a simplified block diagram illustrating inputs and outputs of an exemplary system for providing real-time work and performance visibility, tracking, and analysis for transparent lump sum contracting, in accordance with one or more embodiments.

FIG. 3A is a wireframe of an exemplary project creation page of a user interface for a system for providing real-time work and performance visibility, tracking, and analysis for transparent lump sum contracting, in accordance with one or more embodiments.

FIG. 3B illustrates an exemplary project creation page of a user interface for a system for providing real-time work and performance visibility, tracking, and analysis for transparent lump sum contracting, in accordance with one or more embodiments.

FIG. 4A is a wireframe of an exemplary project summary page of a user interface for a system for providing real-time work and performance visibility, tracking, and analysis for transparent lump sum contracting, in accordance with one or more embodiments.

FIG. 4B illustrates an exemplary project summary page of the user interface in FIG. 4A, in accordance with one or more embodiments.

FIG. 4C is a wireframe of another exemplary project summary page of a user interface for a system for providing real-time work and performance visibility, tracking, and analysis for transparent lump sum contracting, in accordance with one or more embodiments.

FIG. 4D illustrates another exemplary project summary page of the user interface in FIG. 4C, in accordance with one or more embodiments.

FIG. 5A is a wireframe of an exemplary post-project analysis page of a user interface for a system for providing real-time work and performance visibility, tracking, and analysis for transparent lump sum contracting, in accordance with one or more embodiments.

FIG. 5B illustrates an exemplary post-project analysis page of the user interface in FIG. 5A, in accordance with one or more embodiments.

FIG. 6 is a simplified block diagram illustrating an exemplary system architecture for providing real-time work and performance visibility, tracking, and analysis for transparent lump sum contracting, in accordance with one or more embodiments.

FIG. 7 is a flow diagram illustrating data interactions between database tables in a system for providing real-time work and performance visibility, tracking, and analysis for transparent lump sum contracting, in accordance with one or more embodiments.

FIG. 8 is a flow diagram illustrating a method for providing real-time work and performance visibility, tracking, and analysis for transparent lump sum contracting, in accordance with one or more embodiments.

FIG. 9A is a simplified block diagram of an exemplary computing system configured to implement the systems shown in FIGS. 1-2 and 6, interfaces shown in FIGS. 3-5B, and to perform steps of the method illustrated in FIG. 8, in accordance with one or more embodiments.

FIG. 9B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments

### DETAILED DESCRIPTION

The invention is directed to transparent lump sum (TLS) system and methods for providing real-time work and performance visibility, tracking, and analysis for lump sum contracting. The TLS system and methods described herein address these challenges of conventional lump sum contracting methods by providing real-time tracking, performance validation, strategic insights, and commercial insights, delivering significant value to owners, all within one lump sum contracting platform. The capabilities in a TLS platform transform fixed-price work management by providing users with real-time visibility, accurate billing, strategic insights, and enhanced oversight. These features ensure that users can control costs, enforce accountability, and make smarter contracting decisions, ultimately delivering better outcomes compared to traditional lump sum contracts.

Key capabilities of a TLS system include:
Percent Complete Tracking: monitoring earned hours and costs against expected progress, thereby providing a clear view of how work is unfolding, even when it's not billed hourly.
Milestone Payment Scheduling with Documentation: attaching evidence of completed work to payment milestones, creating audit-ready support for every payout.
Double Billing Prevention: personnel-level labor capture and/or 100% labor allocation, plus cross-project tracking to ensure contractors cannot bill twice when working across multiple jobs or contracts.
AI-Powered Insights: automatically surfacing performance trends, missed milestones, or scope concerns in real-time, enabling quick action.
Contract Strategy Comparison (Lump Sum vs. T&M): comparing commercial outcomes across contract types, thereby helping procurement and project leaders decide which approach works best for each scope, team, or vendor.
Change Order & Contingency Oversight: managing evolving scopes with embedded change order workflows and visibility into supplier risk allowances.
Subcontractor and Safety Visibility: maintaining control over all tiers of labor and ensure compliance with fatigue policies, even under fixed-price agreements.
Data for Future Planning and Negotiations: retaining granular performance data to inform future estimates, contracting models, and rate discussions.

### System and Process Flow

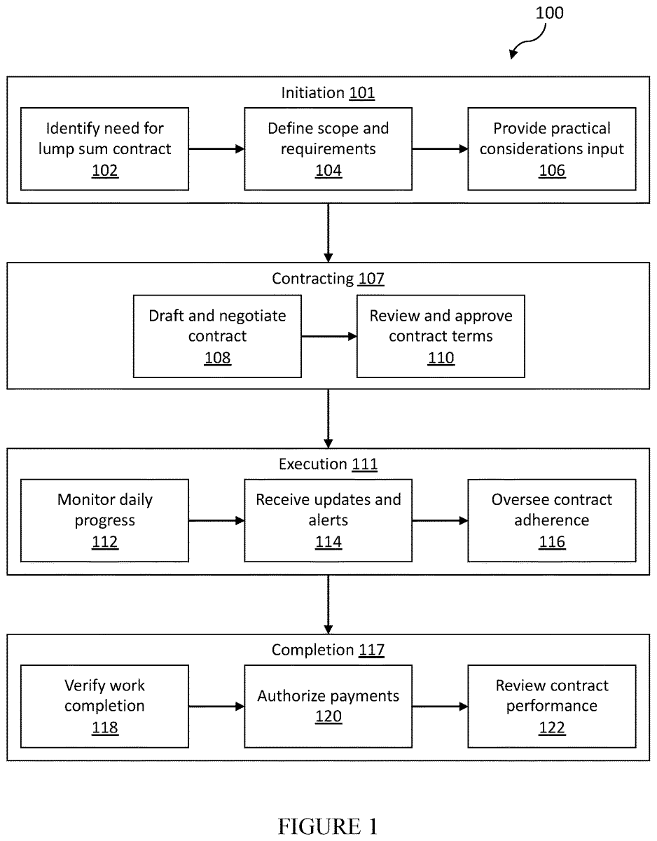

FIG. 1 is a simplified block diagram illustrating an exemplary process for providing real-time work and performance visibility, tracking, and analysis for transparent lump sum contracting, in accordance with one or more embodiments. Process 100 may include a plurality of phases, such as initiation 101, contracting 107, execution 111, and completion 117.

Initiation 101 may include identifying a need for a lump sum contract 102. In some examples, a procurement personnel may use procurement software (e.g., a user interface (UI) provided by a TLS system for project creation and/or contract selection) in order to identify this need by performing an analysis to determine that a lump sum contracting strategy aligns with operational goals and requirements of a project (i.e., job). Initiation 101 also may include defining scope and requirements of the job at step 104, for example, using one or more UIs described herein, thereby providing clear and detailed scope to avoid misunderstandings and scope creep. In some examples, this may comprise input by a plant manager. Initiation 101 also may include providing practical considerations inputs at step 106. This step may include incorporating on-the-ground insights to ensure feasibility and efficiency. Initiation 101 steps result in improved confidence in contracting strategy (e.g., aligns contract strategy with operational goals, thereby reducing risks and ensuring clarity from the start) and enhanced collaboration (e.g., involves all stakeholders in defining the scope, which leads to better planning and execution).

Contracting 107 may include drafting and negotiating a contract 108. In some examples, procurement software (e.g., contract templating and drafting UI provided by a TLS system) may be used by procurement personnel to draft a contract using performance data to determine appropriate rates and select a contracting model that works best. Contracting 107 also may include reviewing and approving contract terms 110 (e.g., a UI provided by the TLS system for contract review by a plant manager and/or other personnel) as a confirmation that contract terms are aligned with operational needs and goals. Contracting 107 steps result in data-driven contract strategy by evaluating which vendors and scopes perform best under different models, leading to better decision-making. Contracting 107 steps also prevent billing errors and scope misalignment through detailed contract terms and real-time validation, thereby reducing financial risk.

Execution 111 may include monitoring daily progress 112, including tracking contractor time, subcontractor activities, and earned hours versus budgeted hours. In some examples, this information may be surfaced (e.g., visualizations or other UI provided by the TLS system) for field operations personnel to view. Execution 111 also may include receiving updates and alerts 114, thereby providing real-time visibility into job progress and contractor performance. In some examples, the updates and alerts may be input into the TLS system by plant managers using one or more of the UIs described herein. Execution 111 also may include overseeing contract adherence 116, including managing change orders and scope adjustments with embedded workflows, as described in more detail below. Execution 111 steps result in operational control and confidence by ensuring compliance with safety and performance standard, reducing disruptions, and improving accountability. Execution 111 further results in clarity by greatly reducing the risk of double billing and improving workforce coordination, leading to better executing and fewer surprises.

Completion 117 may include verifying work completion 118, wherein the TLS system receives confirmation of work completion according to the contract for scheduled payments and submits documentation for the payments (e.g., milestone payments). In some examples, the TLS system may require receiving authorized user authorization (e.g., by a plant manager) after providing to the authorized user the verified completion and performance data, for example, using one or more of the UIs described herein. The TLS system may enable reviewing of contract performance by providing performance data for the project to an authorized user (e.g., a procurement personnel), for example, using one or more of the UIs described herein. Such information may be useful for future planning and negotiations. Completion 117 steps may result in milestone payment accuracy, confirming that work is truly complete before payment is authorized, thereby reducing financial risk. Completion 117 steps also may enhance oversight and governance by maintaining control over and providing visibility across all tiers of labor, thereby confirming compliance with policies and leading to improved outcomes. Finally, completion 117 steps also result in useful data for future planning and negotiations by retaining granular performance data to inform future estimates, contracting models, and rate discussions.

The TLS system described herein may be used to manage large-scale construction projects ensuring that all work is tracked and validated, reducing the risk of overbilling and ensuring that milestones are met. It also may be used for routine and/or recurring maintenance tasks, providing visibility into actual work being performed and ensuring that contractors are held accountable, so that payments are made based on verified progress. In other examples, a TLS system also may manage complex coordination of multiple contractors during plant shutdowns or turnarounds, enable completion of the contract work on time and within budget. In yet other examples, a TLS system also may assist with procurement strategy optimization by providing data and analysis of lump sum versus time and materials contracts so that procurement teams may make data-driven decisions on which contracting strategy works best for different types of work, vendors, and risk profiles. In still other examples, a TLS system may be used for safety and compliance monitoring by providing visibility into subcontractor activities and adherence to policies, such that users of the system may confirm that all safety and compliance requirements are met, even under lump sum agreements.

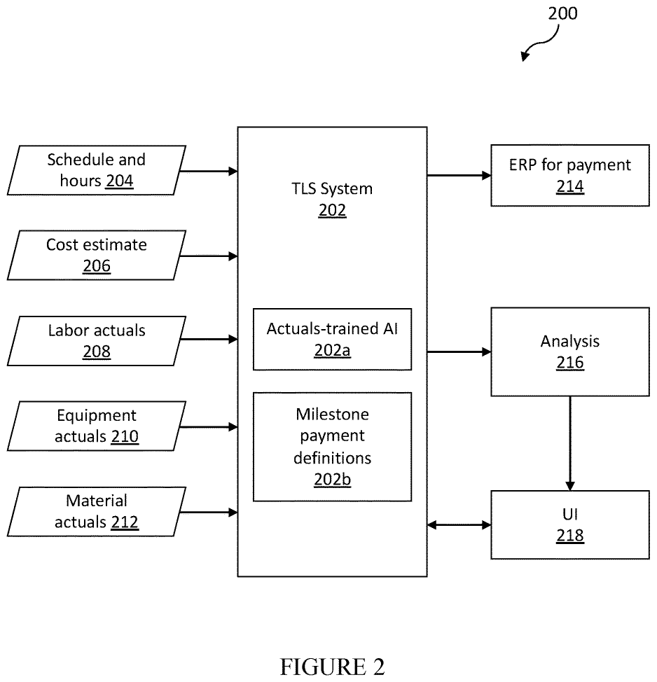

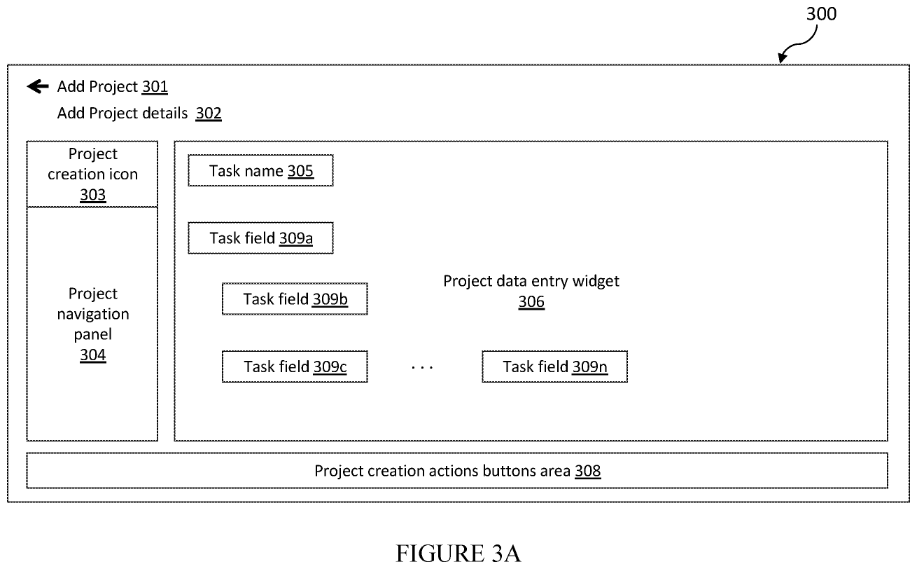

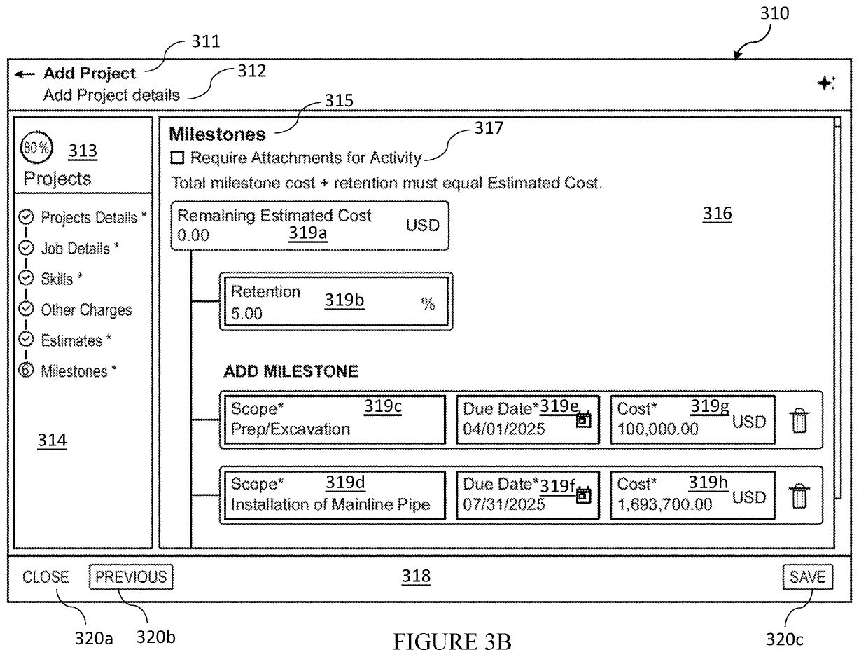

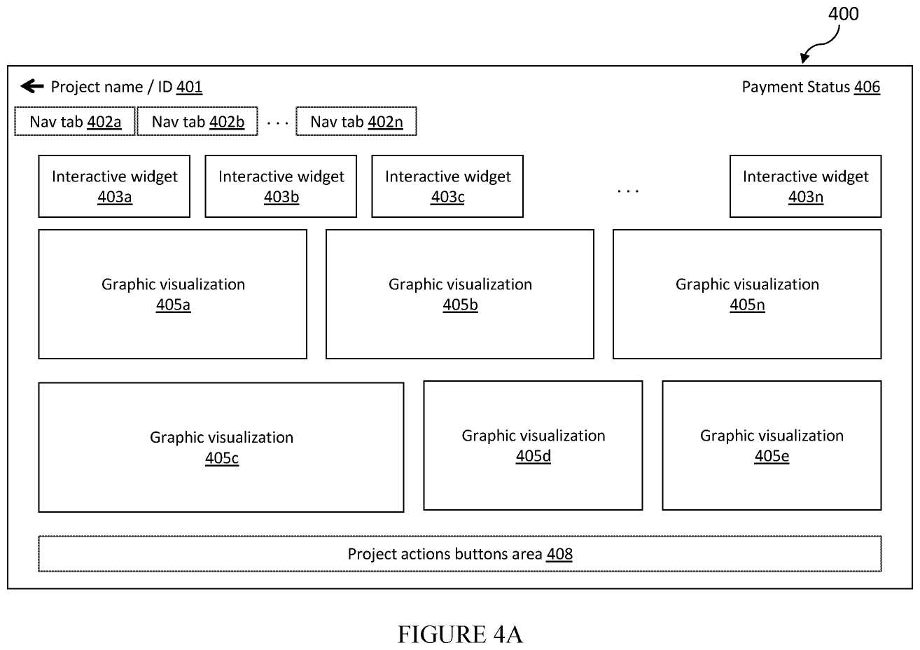

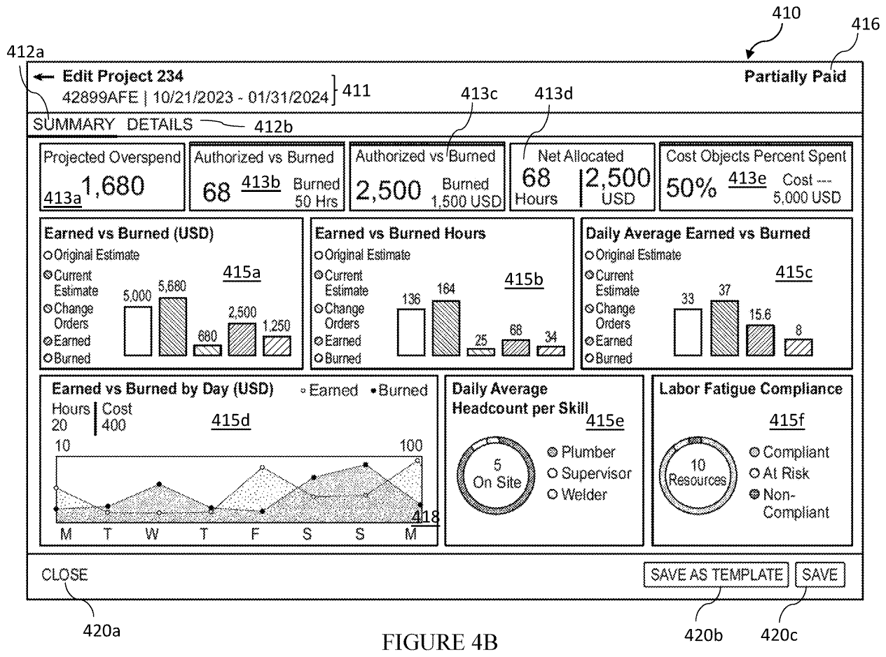

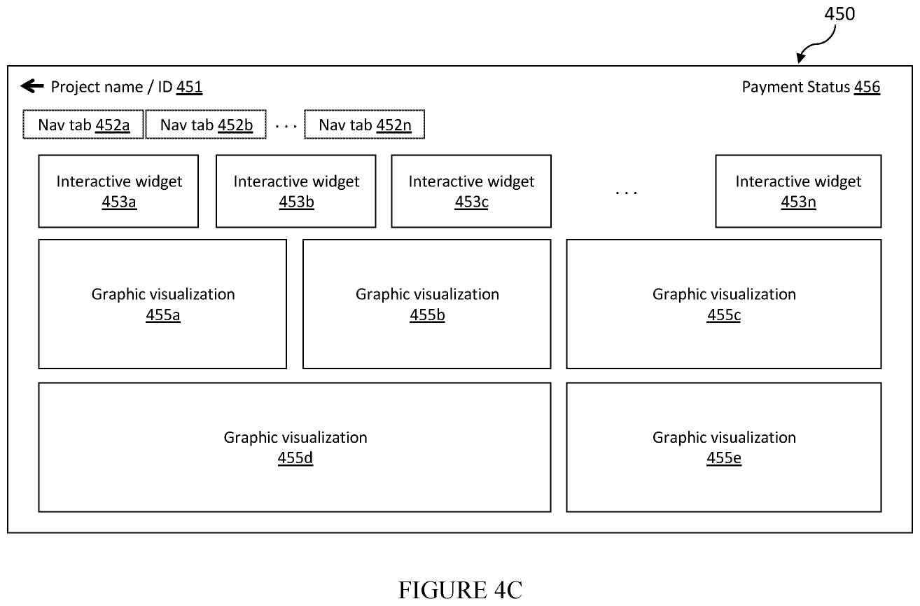

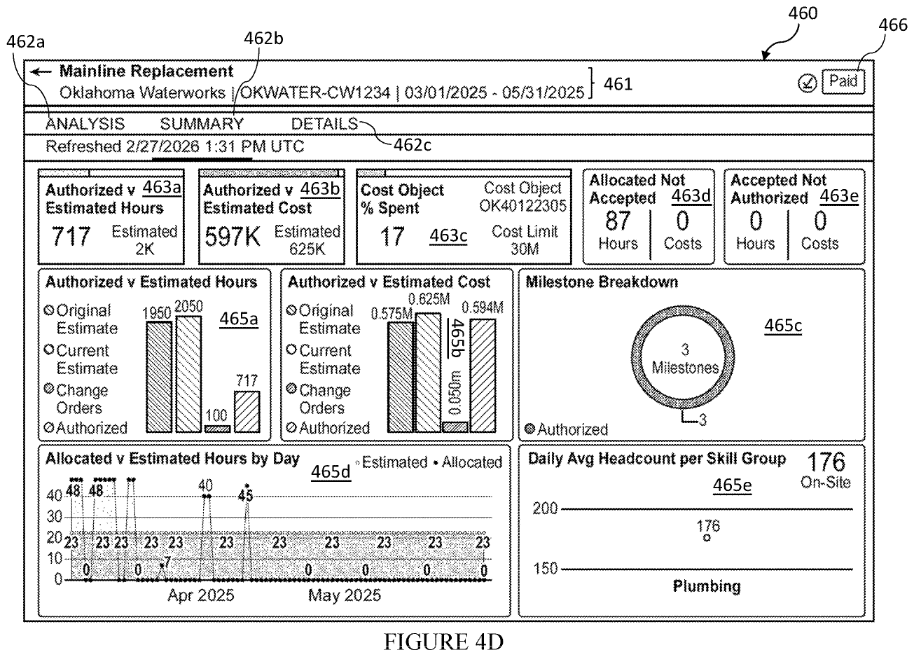

FIG. 2 is a simplified block diagram illustrating inputs and outputs of an exemplary system for providing real-time work and performance visibility, tracking, and analysis for transparent lump sum contracting, in accordance with one or more embodiments. As shown in diagram 200, TLS system 202 (i.e., a real-time work and performance tracking and analysis system for contracting) may be configured to receive (e.g., ingest and process) schedule and hours 204, cost estimate 206, and actuals data relating to labor, equipment, and materials (i.e., labor actuals 208, equipment actuals 210, and material actuals 212). In some examples, one, or a combination, of schedule and hours 204, cost estimate 206, labor actuals 208, equipment actuals 210, and material actuals 212 may be entered into TLS system 202 using one or more of the user interfaces described herein (e.g., FIGS. 3A-3B, 4A-4D). TLS system 202 may use milestone payment definitions 202b and/or actuals-trained AI 202a, the actuals-trained AI 202a being trained on actuals data from similar previously completed projects, in order to generate one or more post-project analyses 216 (e.g., a comparison of amount paid versus job cost, other insights relating to one, or a combination, of performance trends, missed milestones, and scope concerns). In some examples, milestone payment definitions 202b may define work that must be completed before a payment may be authorized. In some examples, milestone payment definitions 202b may be based on definitions provided in a lump sum contract and/or provided in schedule and hours 204 and cost estimate 206. In some examples, the amount paid may comprise a lump sum amount, and the job cost may comprise a cost derived from actuals data. Actuals data being used to train actuals-trained AI 202a may include actual hours at benchmark rates, labor actuals, materials actuals, and equipment actuals from previously completed projects, and other vendor-related data (e.g., preferences, trends, etc.). In some examples, TLS system 202 may enable (e.g., using one or more user interfaces described herein) attachment of documentation of completed work before allowing authorization of a milestone payment. In some examples, TLS system 202 may validate labor actuals 208, equipment actuals 210, and materials actuals 212 against milestone payment definitions 202b to determine milestone percent completion. In some examples, TLS system 202 may be configured to implement (e.g., as part of AI 202a or in conjunction with AI 202a) a time and materials counterfactual cost/comparison engine to model actual job cost (i.e., what the work would have cost under a time and materials calculation using labor allocation data) and/or baseline comparison of lump sum cost versus time and materials cost (e.g., at activity level, at milestone level, etc.).

In some examples, actuals data may comprise actual labor costs, actual equipment costs, and actual materials costs. In some examples, schedule and hours 204 may be sourced from Primavera P6 or other schedule and hours management tool, cost estimate 206 may be sourced from a spreadsheet or other document, labor actuals 208 may be sourced from an access control system (ACS), enterprise resource planning (ERP) client feed, or other record of actual labor expended, equipment actuals 210 may be sourced from an invoice or other record of actual equipment procured and/or used, and material actuals 212 may be sourced from receipts or other record of actual materials procured and/or used. Analysis 216 may provide a comparison of amount paid versus actual job cost (e.g., actual hours expended at benchmark rates, previous similar projects, previous experience with vendors).

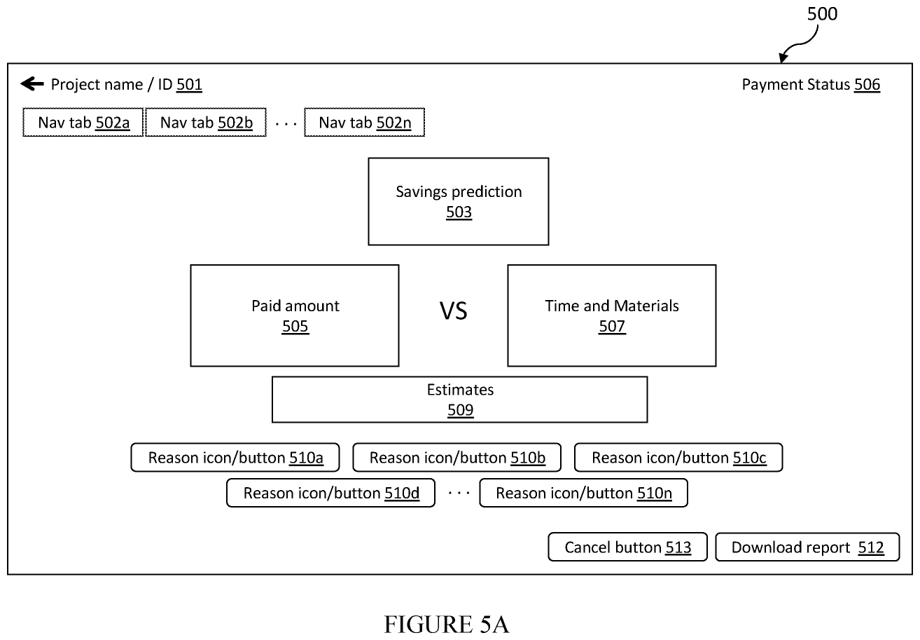

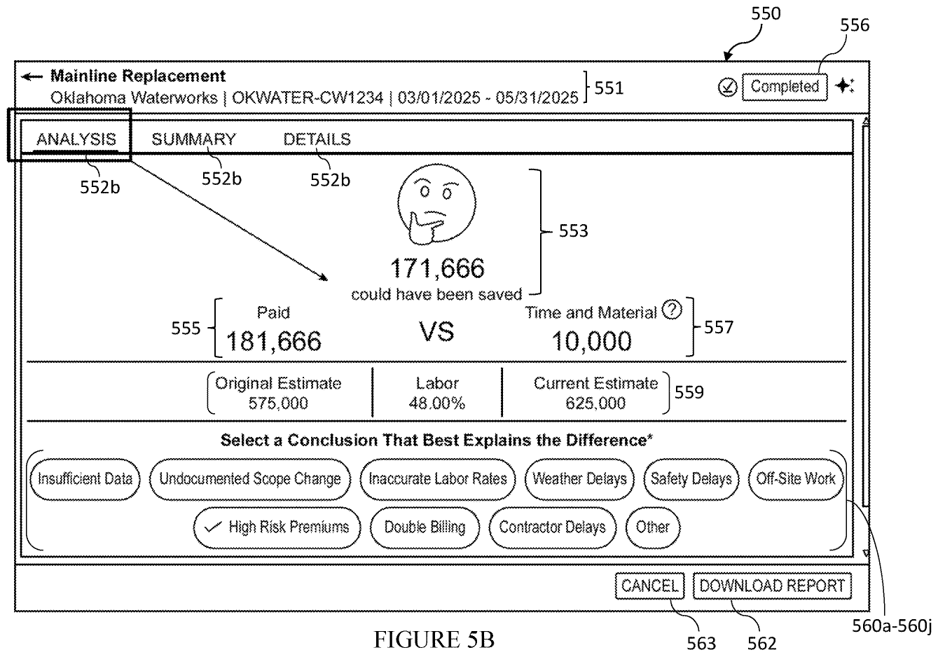

In some examples, TLS system 202 may provide validation, authorization, and other information to an enterprise resource planning (ERP) system 214 for authorized payments (e.g., an ERP with payment integration). In some examples, analysis 216 may be provided to UI 218 to be displayed for a user (e.g., FIGS. 5A-5B). In some examples, UI 218 may comprise one or more elements indicating a savings prediction (e.g., how much was paid for a lump sum contract versus the time and materials cost prediction based on actual hours, equipment and materials), various estimates, and reasons for overpayment or underpayment relative to time and materials, as described in more detail below.

FIG. 3A is a wireframe of an exemplary project creation page of a user interface for a system for providing real-time work and performance visibility, tracking, and analysis for transparent lump sum contracting, in accordance with one or more embodiments. In some examples, a project creation page of a TLS system UI may include fields for inputting information relating to project creation tasks, such as project details, job details, skills, miscellaneous or other additional charges, estimates, and milestones. Said UI also may include visuals relating to project creation progress. Said UI further may include one, or a combination, of a link, a button, a widget, an interactive icon, or other interactive feature for navigating to other pages and/or displays associated with the TLS system. In some examples, wireframe 300 may comprise add project 301, add project details 302, project creation icon 303, project navigation panel 304, project data entry widget 306, and project creation action buttons area 308. In some examples, add project 301 may simply display “Add project” as a title of the UI page. In other examples, add project 301 may comprise a navigation link or button to navigate to an overview add project page, with or without an arrow icon to the left of it. An add project details 302 may similarly display “Add project details” as a descriptor of the UI page, or may comprise a navigation link/button to navigate to another page. Project creation icon 303 may comprise a visualization of the project creation progress (e.g., a circular progress bar, pie chart, or other means of indicating a percent or portion of a project creation checklist that is completed. In some examples, project navigation panel 304 may include a checklist of project creation tasks comprising a link/button for each task, each link/button configured to cause a corresponding project data entry widget 306 to be provided. In some examples, an icon (e.g., a checkmark, a number, a star, an exclamation mark, and other status indicating graphic) may be provided next to each project creation task link/button to indicate a status of the task (e.g., complete, in progress, not-yet-started). There may be a unique project data entry widget 306 corresponding to each task listed in the project navigation panel 304. Project data entry widget 306 may comprise a task name 305 and any number of task fields 309a, 309b, 309c through 309n. There may be any number of task fields in project data entry widget 306, including fewer than shown and more than shown in FIG. 3A. Project creation actions buttons area 308 may include one or more buttons for executing actions relating to the project creation page, such as cancel (i.e., canceling the creation of the project), previous (i.e., navigating to a previous page or previous project), and save (i.e., saving progress on a project creation). In some examples, such buttons may result in navigation to a different page of the UI.

FIG. 3B illustrates an exemplary project creation page of a user interface for a system for providing real-time work and performance visibility, tracking, and analysis for transparent lump sum contracting, in accordance with one or more embodiments. Page 310 may include an add project 311, add project details 312, a project creation icon 313, project navigation panel 314, project data entry widget 316, and project creation action buttons area 318. In this example, project creation icon 313 includes a circular progress bar showing a percent completion over the text “Projects.” In this example, project navigation panel 314 shows project creation task items such as “Project Details,” “Job Details”, “Skills,” “Other Charges,” “Estimates,” and “Milestones.” All tasks apart from “Milestones” has a check mark next to it indicating those tasks are complete. “Milestones” is the 6^{th} task item and has a number 6 next to it. In this example, project data entry widget 316 corresponds to the Milestones task, as indicated by task name 315. In this example, project data entry widget 316 also includes a checkbox 317 to indicate whether or not to require attachments for the activity, along with task fields 319a, 319b, 319c, 319d, 319e, 319f, 319g, and 319h, all relating to the project creation task Milestones (e.g., remaining estimated cost, retention percentage, scope of milestone, due date of milestone, cost of milestone, etc.). In this example, project creation action buttons area 318 includes button 320a, 320b, and 320c (e.g., to close the page, navigate to a previous screen, or save the inputted information).

FIG. 4A is a wireframe of an exemplary project summary page of a user interface for a system for providing real-time work and performance visibility, tracking, and analysis for transparent lump sum contracting, in accordance with one or more embodiments. In some examples, a project summary page of the UI may display one or more graphics and/or visualizations relating to project progress and data. In some examples, wireframe 400 may include project name/ID 401, navigation tabs 402a, 402b through 402n, interactive widgets 403a, 403b, 403c through 403n, graphic visualizations 405a, 405b, 405c, 405d, 405e through 405n, payment status 406, and project action buttons area 408. There may be any number of navigation tabs, interactive widgets, and graphic visualizations in a project summary page, including fewer than depicted and more than depicted in FIG. 4A. In some examples, project name/ID 401 may include text comprising a project name, a link for navigating to another page (e.g., a higher level page in the UI) with or without an arrow icon/button, and identifying information (e.g., ID number, date range, location, start date, end date, entity name) presented next to or underneath the project name. In some examples, navigation tabs 402a, 402b through 402n may comprise interactive tabs for navigating to various displays associated with the project, such as summary, details, analysis, the interactive tabs displaying text indicating the nature of the display to which it navigates (e.g., “summary,” “details,” “analysis”). In some examples, the selected tab, with which the interactive widgets and graphic visualizations are associated, may be highlighted in some way (e.g., different color, underlining, bolding, highlighting, etc.). Interactive widgets 403a-403n may be associated with a selected tab. For example, if a summary tab is selected, one of interactive widgets 403a-403n may show summary information about the project identified in project name/ID 401, including projected overspend, authorized vs. burned/estimated hours, authorized vs. burned/estimated cost, net allocated hours and cost, cost object percent spent, allocated not accepted hours and cost, accepted not authorized hours and cost, and the like. In some examples, interactive widgets 403a-403n may include progress or percent bars along a side (e.g., top, bottom, left, right) of the widget indicating an approximate amount of an allocation used or spent. In some examples, interactive widgets 403a-403n may be related to graphic visualizations 405a-405n, which may comprise charts, graphs, progress bars (e.g., circular, horizontal, vertical, etc.), and other visualizations with more detail regarding the information provided in interactive widgets 403a-403n. For example, interactive widget 403a may show a bar graph with legend indicating overall authorized vs. estimated hours, while graphic visualization 405a may show a dotted line graph of allocated vs. estimated hours by day with additional detail (e.g., shading, lines, callouts) indicating even more data (e.g., averages, ranges, medians, targets, etc.). In some examples, interactive widgets 403a-403n may be selectable, movable, or otherwise manipulated to change the type and location of details provided in graphic visualizations 405a-405n. In some examples, graphic visualizations 405a-405n may include visualizations providing different information about the project from what is shown in interactive widgets 403a-403n. For example, graphic visualizations 405a-405n also may show line graphs, progress bars, and charts, relating to job/project-related data, such as daily average headcount per skill (e.g., amount of total headcount are supervisors, plumbers, electricians, welders, etc.), labor fatigue compliance (percent compliant, percent at risk, percent non-compliant), milestone breakdown (i.e., indicating the number of milestones authorized relative to the total milestones for the project), and other project data.

In some examples, payment status 408 may display text indicating whether the project contract is unpaid, partially paid, paid, delinquent, and other payment status that may be relevant to a project contract. In some examples, an icon may be shown next to the displayed text further indicating said status (e.g., checkmark, question mark, x-mark, thumbs up/down, colored square or circle or other shape, and the like). In still other examples, other status information may be shown in the top right hand corner with or instead of payment status 408. Project actions buttons area 408 may include one or more buttons for executing actions relating to a project summary page, such as close (e.g., closing out of the project or the summary view), save as template (e.g., saving the project summary layout and/or particular combination of information shown), and save (e.g., saving the project summary). In some examples, such buttons may result in navigation to a different page of the UI.

FIG. 4B illustrates an exemplary project summary page of the user interface in FIG. 4A, in accordance with one or more embodiments. Summary page 410 may include project name/ID 411, navigation tabs 412a and 412b, interactive widgets 413a, 413b, 413c, 413d, 413e, graphic visualizations 415a, 415b, 415c, 415d, 415e, 415f, payment status 416, project action buttons area 418, and buttons 420a, 420b, and 420c. In this example, project name/ID 411 comprises a back navigation link displayed as a left arrow with the text “Edit Project 234,” and text below indicating a project ID number and a date range associated with the project (e.g., a term of the contract, expected start and end dates of the project, etc.). In this example, navigation tabs 412a and 412b provide interactive tabs allowing a user to select a page view (e.g., a summary, details, etc.). In this example, “summary” has been selected, as indicated by the darker text and underlining. In this example, interactive widgets 413a-413e show summaries of various aspects of project data including project overspend, authorized vs. burned hours, authorized vs. burned cost, hours and cost not allocated, and cost objects percent spend. In this example, interactive widgets 413a-413e show this data as numbers, and in some examples where the information relates to an amount used (i.e., burned) relative to a total amount (e.g., allocated, authorized, etc.), also with a horizontal progress bar along the top of the widget. In this example, graphic visualizations 415a-415c display bar graphs with legends and title descriptors relating to earned vs. burned costs (i.e., including bars indicating an original estimate, a current estimate, change orders, earned, and burned), a similar bar graph for earned vs. burned hours and daily average earned vs. burned hours. In this example, graphic visualization 415d displays a shaded line graph for earned vs. burned hours and costs by day (e.g., actuals). In this example, graphic visualizations 415e-415f display circular progress bars for daily average headcount per skill (e.g., plumber, supervisor, welder, etc.) and labor fatigue compliance (e.g., compliant, at risk, non-compliant).

FIG. 4C is a wireframe of another exemplary project summary page of a user interface for a system for providing real-time work and performance visibility, tracking, and analysis for transparent lump sum contracting, in accordance with one or more embodiments. In some examples, a project summary page of the UI may display one or more graphics and/or visualizations relating to project progress and data. In some examples, wireframe 450 may include project name/ID 451, navigation tabs 452a, 452b through 452n, interactive widgets 453a, 453b, 453c through 453n, graphic visualizations 455a, 455b, 455c, 455d, 455n, and payment status 456. FIG. 4C comprises an alternative layout of some or all of the elements in FIG. 4A. Like-named elements may function the same or similarly as the corresponding elements described above regarding FIG. 4A-4B. In some examples, page 450 may also include action buttons at the bottom (not shown).

FIG. 4D illustrates another exemplary project summary page of the user interface in FIG. 4C, in accordance with one or more embodiments. Summary page 460 may include project name/ID 461, navigation tabs 462a, 462b, 462c, interactive widgets 463a, 463b, 463c, 463d, 463e, graphic visualizations 465a, 465b, 465c, 465d, 465e, and payment status 466. In this example, project name/ID 461 comprises a back navigation link displayed as a left arrow with the text “Mainline Replacement,” and text below indicating an entity name, a project ID number, and a date range associated with the project. In this example, navigation tabs 462a-462c provide interactive tabs allowing a user to select a page view (e.g., a summary, details, analysis, etc.). In this example, “summary” has been selected, as indicated by the darker text and underlining. In this example, interactive widgets 463a-463e show summaries of various aspects of project data including authorized v. estimated hours, authorized v. estimated cost, cost object percent spend, allocated not accepted hours and costs, accepted not authorized hours and cost. In this example, interactive widgets 413a-413e show this data as numbers, and in some examples where the information relates to an amount used (i.e., estimated) relative to a total amount (e.g., allocated, authorized, etc.), also with a horizontal progress bar along the top of the widget. In this example, graphic visualizations 465a-465b display bar graphs with legends and title descriptors relating to earned vs. estimated costs and hours (i.e., including bars indicating an original estimate, a current estimate, change orders, authorized). In this example, graphic visualization 465c displays a circular progress bar indicating a milestone breakdown of authorized milestones. In this example, graphic visualization 465d displays a shaded line graph for earned vs. estimated hours and costs by day (e.g., actuals). In this example, graphic visualization 415e displays a graph of daily average headcount per skill group (e.g., plumber, supervisor, welder, electrician, other skilled work group, etc.).

In some examples, navigation tabs 412b and 462c may be selected (e.g., clicked on, moused over, tabbed to, and otherwise selected) to show lists, spreadsheets, tables, source data, pseudocode, code, and other details relating to one or more of the summary and analysis information provided in a summary and analysis tab (e.g., navigation tabs 412a, 462a, 462b), respectively. In some examples, the interactive widgets, navigation tabs, and other elements of the user interfaces shown and described herein, may enable navigation to other forms, interfaces, and modules, for entry of relevant data. For example, interactive widgets 413b and 463a may be selected to pull up or navigate to a window, pop-up, website, or other interface that enables a user to enter actual labor data (e.g., hours worked total, hours worked by skill group, hours worked towards a particular milestone, etc.).

FIG. 5A is a wireframe of an exemplary post-project analysis page of a user interface for a system for providing real-time work and performance visibility, tracking, and analysis for transparent lump sum contracting, in accordance with one or more embodiments. In some examples, a post-project analysis may comprise a comparison of amount paid (e.g., lump sum payment) versus a job cost (e.g., based on time and materials, or other actuals data). In some examples, wireframe 500 may include project name/ID 501, navigation tabs 502a, 502b through 502n, savings prediction 503, paid amount 505, payment status 506, time and materials 507, estimates 509, reason icons/buttons 510a, 510b, 510c, 510d through 510n, download report button 512, and cancel button 513. There may be any number of navigation tabs, icons, and buttons in a project analysis page, including fewer than depicted and more than depicted in FIG. 5A. Like-named elements may function the same or similarly as the corresponding elements described above regarding FIG. 4A-4D, such as project name/ID, navigation tab, and payment status. In some examples, saving prediction 503 may display a number or other value indicating an amount that could have been saved. In some examples, saving prediction 503 may include an icon or graphic associated with the amount that could have been saved (e.g., a happy face, a neutral face, an unhappy face, a thumbs up or down, and the like). In some examples, paid amount 505 may indicate an amount paid (e.g., a number, value, etc.) and time and materials 507 may indicate an amount of time and materials (e.g., a number, value, etc.). In some examples, estimates 509 may indicate an original estimate, a percent of labor expended or used, and a current estimate. In some examples, reason icons/buttons 510a-510n may indicate a plurality of possible reasons for the difference between the amount paid and the actual time and materials (e.g., insufficient data, undocumented scope change, inaccurate labor rates, weather delays, safety delays, off-site work, high risk premiums, double billing, contractor delays, other, etc.). In some examples, one or more of reason icons/buttons 510a-510n may be indicated as selected (e.g., with a check mark, highlighting, color difference, bold, italics, or other selection indication) to show the likely reasons for the difference between the amount paid and the actual time and materials expended and used. Download report button 512 and cancel button 513 may comprise interactive buttons for selecting actions relating to the analysis information shown on page 500.

FIG. 5B illustrates an exemplary post-project analysis page of the user interface in FIG. 5A, in accordance with one or more embodiments. Analysis page 550 may include project name/ID 551, navigation tabs 552a, 552b, 552c, savings prediction 553, paid amount 555, payment status 556, time and materials 557, estimates 559, reason icons/buttons 560a,-560j, download report button 562, and cancel button 563. In this example, project name/ID 551 comprises a back navigation link displayed as a left arrow with the text “Mainline Replacement,” and text below indicating an entity name, a project ID number, and a date range associated with the project. In this example, navigation tabs 552a-552c provide interactive tabs allowing a user to select a page view (e.g., a summary, details, analysis, etc.). In this example, “analysis” has been selected, as indicated by the darker text and underlining. In this example, savings prediction 553 displays a number (e.g., a dollar amount, other value, etc.) that “could have been saved,” with an emoji icon above the number (e.g., indicating there could have been significant savings). In some examples, the number may have been computed, calculated, or predicted by a TLS system, as described herein. In this example, paid amount 555 indicates with a number (e.g., dollar amount, other value, etc.) the amount paid for the project, and time and materials 557 indicates with a number (e.g., dollar amount, hours amount, other value, etc.) the amount of time and materials actually expended and used. In this example, estimates 559 shows an original estimate of 575,000, a labor usage of 48%, and a current estimate of 625,000. In this example, underneath the text “Select a Conclusion That Best Explains the Difference*,” a plurality of reason icons/buttons 560a-560j are provided, including insufficient data, undocumented scope change, in accurate labor rates, weather delays, safety delays, off-site work, high risk premiums, double billing, contractor delays, and other. High risk premiums is shown as selected with a darker outline and text and a checkmark. In some examples, the UI may be configured for a user to select one or more reason icons/buttons 560a-560j. In other examples, the TLS system may perform an analysis to determine which of the reason icons/buttons 560a-560j best explains the difference between paid amount 555 and time and materials 557, and so one or more of the reason icons/buttons 560a-560j may be selected by the TLS system.

In this example, payment status 556 indicates a completed payment with both a checkmark icon and text showing “Completed.” In some examples, buttons 562-563 may comprise interactive action buttons allowing a user to take an action relating to the analysis report shown (e.g., download the report, cancel the report, etc.). In other examples, other insights generated by a TLS system may also be shown, including additional data, sources of data, explanations and reasons for amounts that could have been saved, and the like.

In still other examples, other user interfaces may be generated by a TLS system associated with milestone transactions, project summary, change orders, daily activity/allocations, and other aspects of a lump sum contracting project.

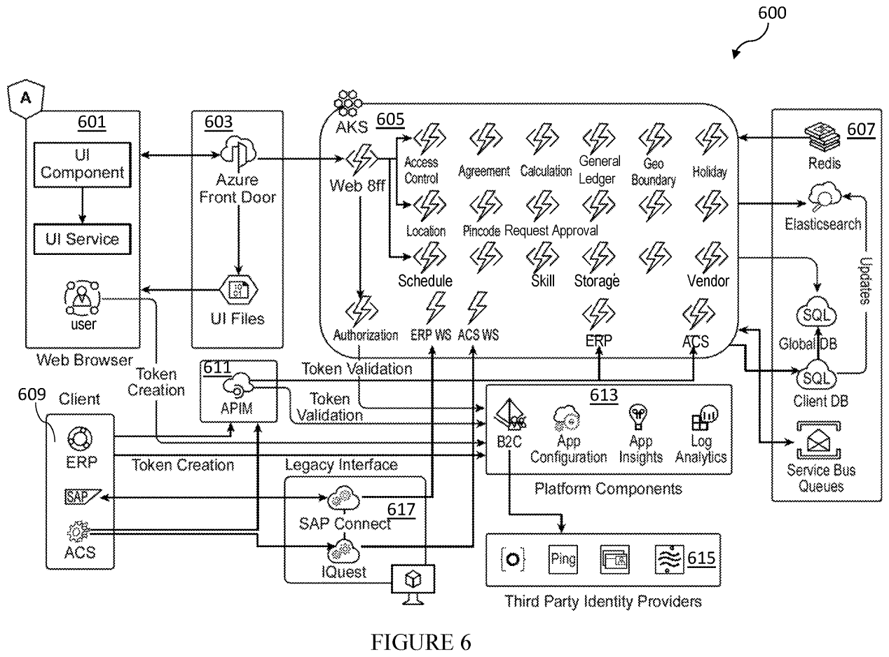

FIG. 6 is a simplified block diagram illustrating an exemplary system architecture for providing real-time work and performance visibility, tracking, and analysis for transparent lump sum contracting, in accordance with one or more embodiments. System 600 may include a web browser 601, cloud network/storage 603, Kubernetes service 605, one or more databases and/or data storage 607, enterprise resource planning (ERP) client 609, API management layer (APIM) 611, platform components 613, third party identity providers 615, and optionally, legacy interface 617. In some examples, web browser 601 may include UI component 601a and UI service 601b by which a user may access and engage with system 600. In some examples, cloud network/storage 603 may include a cloud content delivery network (CDN) 603a (e.g., including an application acceleration service) and UI files 603b. In some examples, Kubernetes service 605 may comprise Azure Kubernetes service (AKS) or other service for deploying, scaling, and managing a plurality of containerized applications (e.g., actions, user interfaces, pages). Such containerized applications may include a web backend-for-frontend (BFF), authorization, access control, agreement, calculation, general ledger, a geo boundary, holiday, location, pincode, a schedule, request approval, resource, resource activity, skills, storage (e.g., Blob Storage for attachments), tenant, vendor, an ERP, an ACS, an ERP web service, an ACS web service, and more. In some examples, one or more databases and/or data storage 607 may include a global database (e.g., SQL), a client database (e.g., SQL), a search and analytics engine (e.g., Elasticsearch); one or more databases (e.g., global database, client database) and other data structures (e.g., Redis), and messaging tools (e.g., Service Bus queue, Java message service, etc.). In some examples, clients 609 may comprise one or more of SAP, ACS, and other ERP client. In some examples, APIM 611 may be configured to receive and manage data from any or all of client 609, as well as a user via web browser 601 across the cloud environment shown in system 600 (e.g., performing token validation and providing data to relevant applications in Kubernetes service 605. In some examples, platform components 613 may comprise a plurality of platform resources (e.g., a B2C active directory, app configuration, app insights, log analytics, etc.), for example, for token creation, validation, and other authentication actions, using third party identity providers 615. In some examples, legacy interface 617 may be used as an interface between a client 609 and an application in Kubernetes service 605. System 600 may be configured to implement a plurality of services relating to the systems and methods described herein, including without limitation:

### Transparent Lump Sum Project Services

/api/lumpsum/projects/agreements—Get Agreements with projects
/api/lumpsum/project—Create a Project/api/lumpsum/project/id/{id}—Get a Project by
ID/api/lumpsum/projects/filter—Filter Projects/api/lumpsum/projects—Delete Multiple
Projects/api/lumpsum/project/attachments—Upload Project
Attachments/api/lumpsum/project/conclusion—Get Data for Project
Conclusion/api/lumpsum/projects/validate/associations—Validate Project
Associations/api/lumpsum/project/validate/name—Validate the Name of a Project

### Transparent Lump Sum Activity Services

/api/lumpsum/activity—Create Activity
/api/lumpsum/activity/id/{id}—Get Activity by ID
/api/lumpsum/activities/filter—Filter Activities
/api/lumpsum/activities—Delete Multiple Activities
/api/lumpsum/activity/attachments—Upload Activity Attachments

### Transparent Lump Sum Allocation Services

/api/allocations/lumpsum—Create Lumpsum allocations/lumpsum
/api/allocations/rejected/lumpsum—Get Rejected Lump Sum Allocations For View
/api/allocations/lumpsum/unresolved—Get Unresovled Lump Sum Allocations
/api/allocations/allocated/lumpsum—Get Lump Sum Allocations for View
/api/allocations/lumpsum/activities—Get Lump Sum Activities ready for Allocations
/api/allocations/lumpsum/allocated/ids—Delete Lump Sum Allocations

### Change Order Services

/api/lumpsum/changeorder—Create Change Order
/api/lumpsum/changeorder/id/{id}—Get Change Order By ID/api/lumpsum/changeorders/filter
Filter Change Orders/api/lumpsum/changeorders—Delete Multiple Change
Orders/api/lumpsum/changeorder/attachments—Upload Change Order
Attachment/api/lumpsum/changeorder/validate/name—Validate Change Order
Name/api/lumpsum/changeorders/approve—Approve multiple Change
Order/api/lumpsum/changeorders/reject—Reject

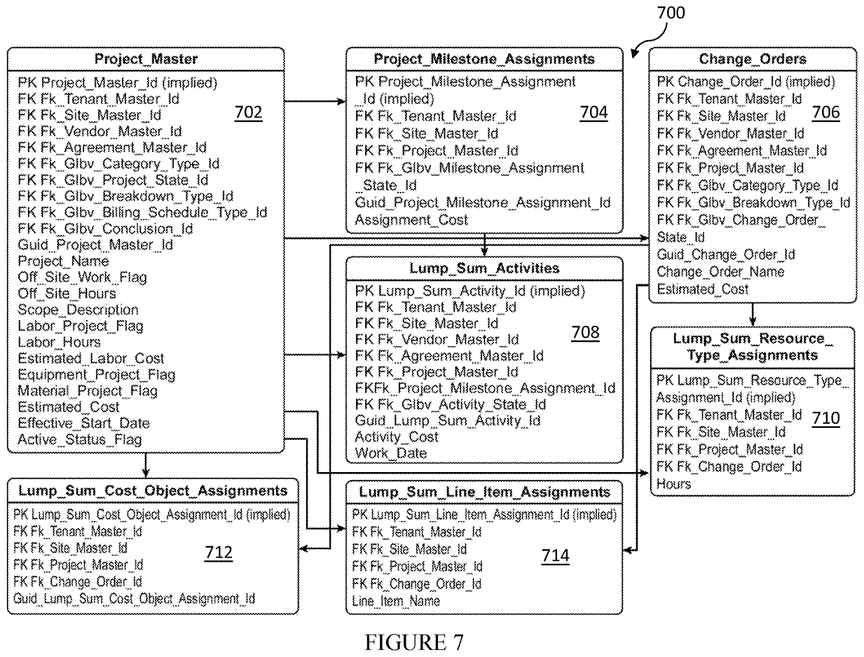

FIG. 7 is a flow diagram illustrating data interactions between database tables in a system for providing real-time work and performance visibility, tracking, and analysis for transparent lump sum contracting, in accordance with one or more embodiments. Diagram 700 includes Project_Master table 702, Project_Milestone_Assignments table 704, Change Orders table 706, Lump_Sum_Activities table 708, Lump_Sum_Resource_Type_Assignments table 710, Lump_Sum_Cost_Object_Assignments table 712, and Lump_Sum_Line_Item_Assignments table 714. A TLS system may be configured to store these tables, for example in one or more databases and/or data storage 607 (FIG. 6). In some examples, Project_Master table 702 may comprise a central table containing core project information including costs, labor hours, and other project-specific data. In some examples, Project_Milestone_Assignments table 704 may be linked to Project_Master table 702, and be configured to track milestone assignments within projects. In some examples, Lump_Sum_Activities table 709 may be connected to both Project_Master table 702 and Project_Milestone_Assignments table 704 and be configured to track specific activities with their costs and work dates. In some examples, Change_Orders table 706 may be related to Project_Master table 702, capturing modifications to the original project scope with their own cost estimates. In some examples, Lump_Sum_Cost_Object_Assignments table 712 may link projects and change orders to cost objects like purchase orders and work breakdown structures. In some examples, Lump_Sum_Line_Item_Assignments table 714 may contain detailed line items associated with projects or change orders. In some examples, Lump_Sum_Resource_Type_Assignments table 710 may track resource allocations (like hours) for projects or change orders.

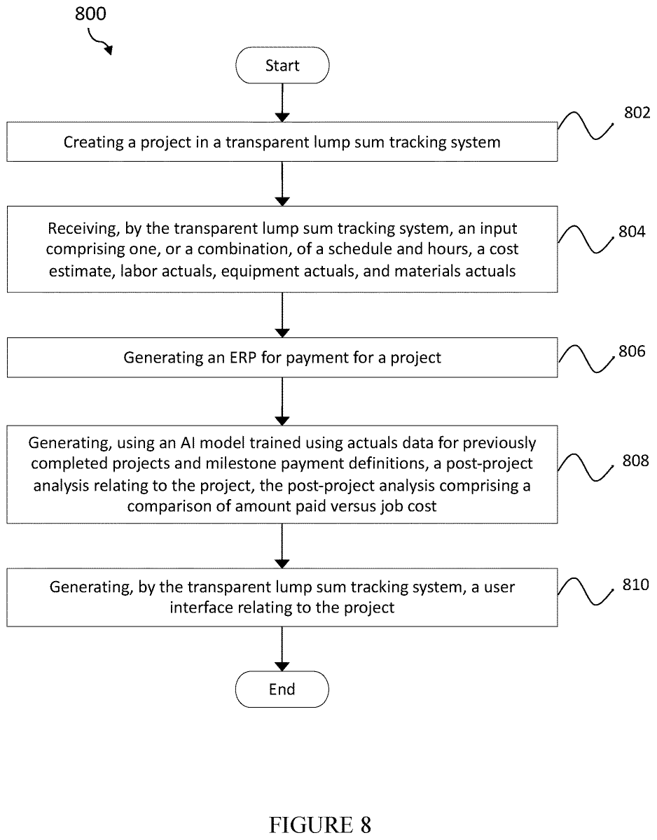

FIG. 8 is a flow diagram illustrating a method for providing real-time work and performance visibility, tracking, and analysis for transparent lump sum contracting, in accordance with one or more embodiments. Method 800 may begin with creating a project in a transparent lump sum (TLS) tracking system at step 802. An input may be received by the transparent lump sum tracking system at step 804, the input comprising one, or a combination, of a schedule and hours, a cost estimate, labor actuals, equipment actuals, and materials actuals. An ERP for payment may be generated at step 806 for a project (i.e., a lump sum contracting project). A post-project analysis may be generated at step 808, using an AI model trained using actuals data for previously completed projects and milestone payment definitions, the post-project analysis relating to the project and comprising a comparison of amount paid versus job cost. In some examples, the post-project analysis also may include additional insights, for example, indicating a reason or conclusion to explain the difference, comparisons to costs for the same project using other contracting models, and other insights. In some examples, the post-project analysis may be based on a prediction and/or computation of actual job cost (i.e., time and materials cost) by the actuals-trained AI model, as described herein. In some examples,

A user interface relating to the project also may be generated by the transparent lump sum tracking system at step 810. As described herein, the user interface may provide a project creation interface, a project operations interface, and a post-project analysis interface or report, among others. As described herein, the user interface may include fields and/or forms for entering data to track actual hours (i.e., time), equipment, and materials used in each phase of a project (e.g., for milestone validation, for comparison/prediction against time and materials model, aka actual job cost, to evaluate/predict cost savings). The user interface also may display interactive widgets, navigation tabs, project information, visualizations, action buttons, and various other user interface elements related to a TLS system and methods as described herein.

While the systems and methods described have been directed to transparent lump sum contracting, similar techniques may be applied to transparent unit rate contracting as well. Unit Rate contracting provides a fixed-price model based on quantities of work completed rather than total scope. In a TLS system, labor hours on Unit Rate jobs are recorded at $0/hour, even though they're not billable. This enables calculation of an effective labor cost by dividing total Unit Rate spend by labor hours worked, allowing direct comparison with Time & Materials (T&M) jobs. With this approach, a user can
Assess which model (Unit Rate or T&M) yields higher productivity per labor hour.
Determine contractor performance consistency across contracting types.
Analyze performance by job type, craft, vendor, and strategy.
   These insights support smarter, data-driven contracting decisions to improve cost efficiency and productivity.

The methods and systems described herein ensure double billing does not occur by tracking all labor activity. For example, the TLS system may be configured for 100% labor allocation such that a user can protect themselves against the same employees and employee hours showing up on separate invoices (e.g., one for time and materials, another for lump sum). The TLS system also may be configured to track employee numbers and hours by skill (i.e., craft) type. The TLS system further may be configured to track change orders (e.g., change order activity versus original estimate labor). The

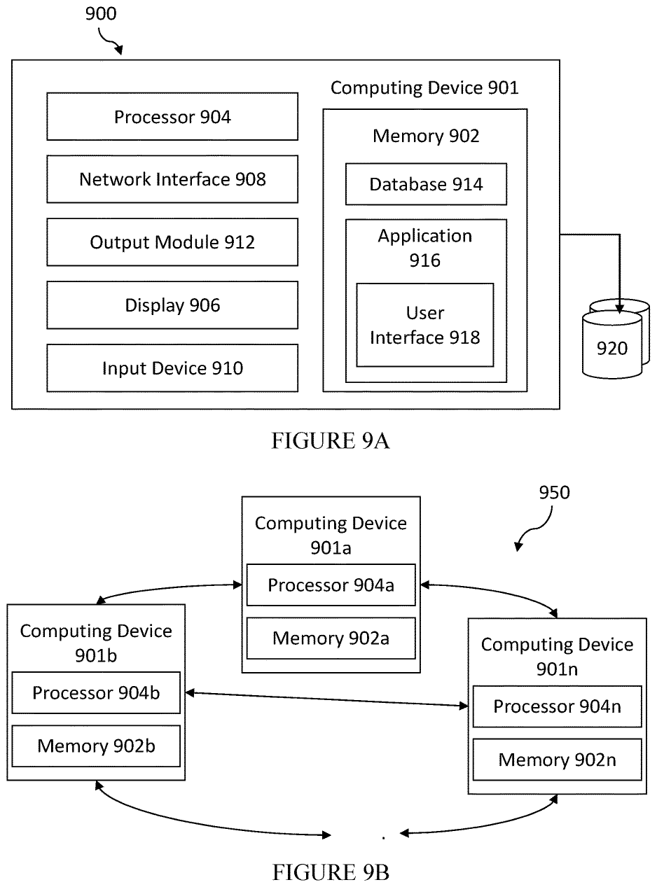

FIG. 9A is a simplified block diagram of an exemplary computing system configured to implement the systems shown in FIGS. 1-2 and 6, interfaces shown in FIGS. 3-5B, and to perform steps of the method illustrated in FIG. 8, in accordance with one or more embodiments. In one embodiment, computing system 900 may include computing device 901 and storage system 920. Storage system 920 may comprise a plurality of repositories and/or other forms of data storage, and it also may be in communication with computing device 901. In another embodiment, storage system 920, which may comprise a plurality of repositories, may be housed in one or more of computing device 901. In some examples, storage system 920 may store data and datasets (e.g., project data, database tables, actuals data, other metadata and metrics, etc.), parameters, preferences, instructions, programs, AI models, other neural networks, other models, and various types of other information as described herein. This information may be retrieved or otherwise accessed by one or more computing devices, such as computing device 901, in order to perform some or all of the features described herein. Storage system 920 may comprise any type of computer storage, such as a hard-drive, memory card, ROM, RAM, DVD, CD-ROM, write-capable, and read-only memories. In addition, storage system 920 may include a distributed storage system where data is stored on a plurality of different storage devices, which may be physically located at the same or different geographic locations (e.g., in a distributed computing system such as system 950 in FIG. 9B). Storage system 920 may be networked to computing device 901 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 901 also may include a memory 902. Memory 902 may comprise a storage system configured to store a database 914 and an application 916. Application 916 may include instructions which, when executed by a processor 904, cause computing device 901 to perform various steps and/or functions, as described herein. Application 916 further includes instructions for generating a user interface 918 (e.g., graphical user interface (GUI) and other UIs, as described herein). Database 914 may store various algorithms and/or data, including neural networks, other AI models, other learning models, data associated with projects, neural networks, cost analyses, user preferences, among other types of data. Memory 902 may include any non-transitory computer-readable storage medium for storing data and/or software that is executable by processor 904, and/or any other medium which may be used to store information that may be accessed by processor 904 to control the operation of computing device 901.

Computing device 901 may further include a display 906, a network interface 908, an input device 910, and/or an output module 912. Display 906 may be any display device by means of which computing device 901 may output and/or display data. Network interface 908 may be configured to connect to a network using any of the wired and wireless short range communication protocols described above, as well as a cellular data network, a satellite network, free space optical network and/or the Internet. Input device 910 may be a mouse, keyboard, touch screen, voice interface, and/or any or other hand-held controller or device or interface by means of which a user may interact with computing device 901. Output module 912 may be a bus, port, and/or other interface by means of which computing device 901 may connect to and/or output data to other devices and/or peripherals

In one embodiment, computing device 901 is a data center or other control facility (e.g., configured to run a distributed computing system as described herein), and may communicate with a client device. As described herein, system 900, and particularly computing device 901, may be used for tracking costs, time, materials associated with a project for payment in accordance with an executed contract, for implementing AI models trained on actuals data to analyze paid amounts versus actual time and materials spent, and otherwise implementing steps in a method for real-time work and performance visibility, tracking, and analysis for transparent lump sum contracting, as described herein. Various configurations of system 900 are envisioned, and various steps and/or functions of the processes described herein may be shared among the various devices of system 900 or may be assigned to specific devices

FIG. 9B is a simplified block diagram of an exemplary distributed computing system implemented by a plurality of the computing devices, in accordance with one or more embodiments. System 950 may comprise two or more computing devices 901a-n. In some examples, each of 901a-n may comprise one or more of processors 904a-n, respectively, and one or more of memory 902a-n, respectively. Processors 904a-n may function similarly to processor 904 in FIG. 9A, as described above. Memory 902a-n may function similarly to memory 902 in FIG. 9A, as described above. One or more computing devices 901a-n may implement a server-side processer, as described herein. One or more other of computing devices 901a-n may implement a client-side processor or component, as described herein

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A system for real-time work and performance visibility, tracking, and analysis for transparent lump sum contracting, the system comprising:
a processor;
a database configured to store a plurality of database tables, including one, or a combination, of a project master table, a lump sum cost object assignments table, a project milestone assignments table, a lump sum activities table, a lump sum line item assignments table, a change orders table, and a lump sum resource type assignments table; and
a memory comprising program instructions executable by the processor to cause the processor to implement:
a set of applications configured to track actual time and materials spent, and execute payments, for a project associated with a lump sum contract;
an AI model configured to generate a post-project analysis relating to the lump sum contract project, the AI model trained using actuals data for previously completed projects and milestone payment definitions; and
a user interface configured to enable project creation and to generate a visualization associated with the post-project analysis.

2. The system of claim 1, wherein the processor further implements a Kubernetes service configured to deploy and manage the set of applications.

3. The system of claim 2, wherein the Kubernetes service is configured to receive data from a web browser implementing a user interface component.

4. The system of claim 2, wherein the Kubernetes service is configured to receive data from an enterprise resource planning client.

5. The system of claim 1, wherein the actuals data comprises one, or a combination, of labor actuals, equipment actuals, and materials actuals.

6. The system of claim 1, wherein the processor further implements an API management layer.

7. The system of claim 1, wherein the project master table comprises a central table containing core project information.

8. The system of claim 1, wherein the lump sum cost object assignments table links a project and/or a change order to a cost object.

9. The system of claim 1, wherein the project milestone assignments table links to the project master table and tracks milestone assignments within the project.

10. The system of claim 1, wherein the lump sum activities table links to one or both of project master table and project milestone assignments table, the lump sum activities table being configured to track an activity with its cost and work date(s).

11. The system of claim 1, wherein the lump sum line item assignments table contains line items associated with the project and/or a change order.

12. The system of claim 1, wherein the change orders table is configured to capture a modification to a project scope, the change orders table further including a cost estimate for the modification.

13. The system of claim 1, wherein the lump sum resource type assignments table is configured to track resource allocation for the project or a change order.
